(19) United States
(12) Patent Application Publication
(10) Pub. No.: US 2026/0070327 A1
(43) Pub. Date: Mar. 12, 2026

(54) PRINTING APPARATUS AND CONTROL METHOD FOR PRINTING APPARATUS

(71) Applicant: MIMAKI ENGINEERING CO., LTD., Nagano (JP)

(72) Inventor: Kenji Harayama, Nagano (JP)

(73) Assignee: MIMAKI ENGINEERING CO., LTD., Nagano (JP)

(21) Appl. No.: 19/243,679

(22) Filed: Jun. 19, 2025

(30) Foreign Application Priority Data
Sep. 10, 2024 (JP) 2024-156573

(51) Int. Cl. B41J 2/045

(52) U.S. Cl. CPC B41J 2/04508; B41J 2/0451; B41J 2/04551; B41J 2/04586

(57) ABSTRACT

A printing apparatus includes a plurality of heads that eject ink, and a control unit that includes a storage unit that stores setting information related to settings of the plurality of heads, and causes the plurality of heads to perform an ejection operation that ejects the ink based on the setting information stored in the storage unit, in which the setting information includes void information related to a setting for setting at least one of the plurality of heads as a void head, and when the void head is present among the plurality of heads, the control unit performs control to cause the head that is not the void head among the plurality of heads to eject the ink and not to cause the void head to eject the ink in the ejection operation.

### CROSS REFERENCE TO RELATED APPLICATIONS

This application claims the priority benefit of Japanese Patent Application No. 2024-156573, filed on September 10, 2024. The entirety of the above-mentioned patent application is hereby incorporated by reference herein and made a part of this specification.

### TECHNICAL FIELD

The present disclosure relates to a printing apparatus and a control method for the printing apparatus.

### DESCRIPTION OF THE BACKGROUND ART

As printing apparatuses that print on media, inkjet printing apparatuses that eject ink from a plurality of heads onto media are known (see, for example, Japanese Patent No. 3858680).

In a printing apparatus such as that described above, when performing an ejection operation, it is detected whether or not there are any defects such as clogged nozzles or a lack of ink filling for each head, and the operation is performed when no defective head is detected. In other words, when even one defective head is detected, an error occurs and no operation is performed. On the other hand, when an ejection operation is performed using a plurality of heads, some heads may not be used depending on the operation content. Therefore, even when a defect is detected only in a head that is not scheduled to be used, the ejection operation is not performed.

The present disclosure provides a printing apparatus that is capable of efficiently performing an ejection operation using a plurality of heads, and a control method for the printing apparatus.

### SUMMARY

A printing apparatus according to the present disclosure includes a plurality of heads that eject ink, and a control unit that includes a storage unit that stores setting information related to settings of the plurality of heads, and causes the plurality of heads to perform an ejection operation that ejects the ink based on the setting information stored in the storage unit, in which the setting information includes void information related to a setting for setting at least one of the plurality of heads as a void head, and when the void head is present among the plurality of heads, the control unit performs control to cause the head that is not the void head among the plurality of heads to eject the ink and not to cause the void head to eject the ink in the ejection operation.

A control method for a printing apparatus according to the present disclosure is a control method for a printing apparatus including a plurality of heads that eject ink, and a control unit that includes a storage unit that stores setting information related to settings of the plurality of heads, and causes the plurality of heads to perform an ejection operation that ejects the ink based on the setting information stored in the storage unit, the setting information includes void information related to a setting for setting at least one of the plurality of heads as a void head, and the control method includes performing control, when the void head is present among the plurality of heads, to cause the head that is not the void head among the plurality of heads to eject the ink and not to cause the void head to eject the ink in the ejection operation.

According to the present disclosure, it is possible to efficiently perform the ejection operation using a plurality of heads.

### BRIEF DESCRIPTION OF THE DRAWINGS

FIG. 1 is a schematic diagram illustrating an example of a printing apparatus according to an embodiment.

FIG. 2 is a diagram illustrating a configuration of an ejection unit as viewed from below (from a -Z side).

FIG. 3 is a block diagram illustrating an example of a control unit.

FIG. 4 is a diagram schematically illustrating an example of ink set information.

FIG. 5 is a diagram schematically illustrating another example of the ink set information.

FIG. 6 is a diagram schematically illustrating another example of the ink set information.

FIG. 7 is a diagram schematically illustrating an example of defect information.

FIG. 8 is a flowchart illustrating an example of a control method for the printing apparatus according to the embodiment.

### DETAILED DESCRIPTION OF EMBODIMENTS

Hereinafter, exemplary embodiments of the present disclosure will be described in detail with reference to the accompanying drawings. Note that the present disclosure is not limited to these embodiments, and when there are a plurality of embodiments, the present disclosure also includes configurations in which the respective embodiments are combined.

In the present embodiment, directions in the drawings will be described using an XYZ coordinate system. In this XYZ coordinate system, a plane parallel to a floor surface on which a printing apparatus is placed is defined as an XY plane. In addition, in the XY plane, a scanning direction (main scanning direction) of an ejection unit 10 and heads 11 to be described later is referred to as a Y direction, and a direction (sub scanning direction) orthogonal to the Y direction on the XY plane is referred to as an X direction. Moreover, a direction perpendicular to the XY plane is referred to as a Z direction. In each of the X direction, the Y direction, and the Z direction, it is assumed that a direction of an arrow in the drawing is a + direction, and a direction opposite to the direction of the arrow is a - direction. In the present embodiment, the +Z direction may be referred to as the upward direction.

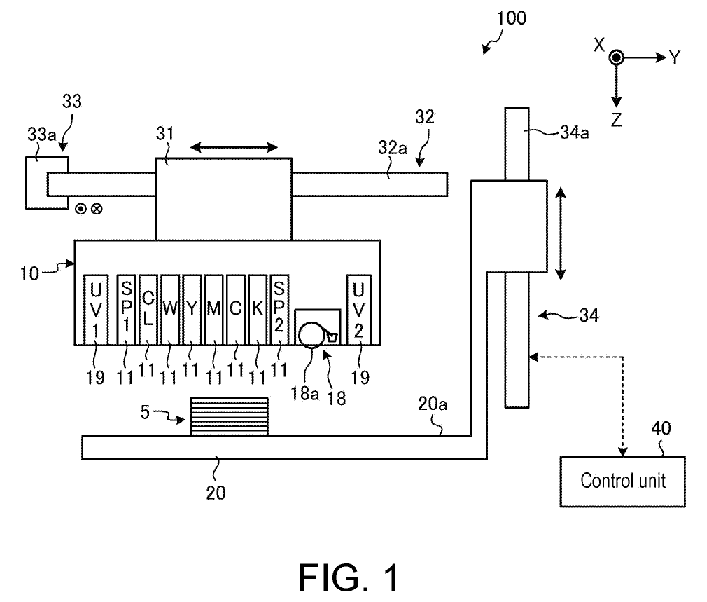

FIG. 1 is a schematic diagram illustrating an example of a printing apparatus 100 according to an embodiment. The printing apparatus 100 illustrated in FIG. 1 is a three-dimensional shaping apparatus (three-dimensional printer) that shapes a shaped object 5 by a layered shaping method. The layered shaping method is, for example, a method of shaping the shaped object 5 by overlapping a plurality of layers. In the present embodiment, the shaped object 5 is, for example, a three-dimensional structure. Here, a case of performing shaping based on the information about the shape and color of the three-dimensional structure to be shaped will be described as an example, but the present disclosure is not limited to this case, and for example, shaping may be performed without using the information about the color.

Except for the points described below, the printing apparatus 100 may have a configuration same as or similar to a known three-dimensional printer. Furthermore, the printing apparatus 100 may be, for example, an inkjet printer that prints characters, images, and the like on various media, or may be one in which a part of the configuration of the inkjet printer is changed.

As illustrated in FIG. 1, the printing apparatus 100 includes an ejection unit 10, a shaping table 20, a driving unit 30, and a control unit 40.

The ejection unit 10 ejects ink to become the material of the shaped object 5 to form an ink layer, flattens the formed ink layer, and cures the flattened ink layer. The ejection unit 10 includes a plurality of heads 11, a flattening roller unit 18, and an ultraviolet irradiating unit 19. The plurality of heads 11 eject ink. Each head 11 has a plurality of nozzles 11a on a surface facing the shaping table 20. The plurality of nozzles 11a are arranged, for example, side by side in the sub scanning direction. The plurality of nozzles 11a eject the ink toward the shaping table 20. The flattening roller unit 18 flattens the ink layer that has landed on the shaping table 20. The ultraviolet irradiating unit 19 irradiates the ink layer with ultraviolet light to cure the ink layer. A detailed configuration of the ejection unit 10 will be described later. The printing apparatus 100 includes an ink supply source (not illustrated) that supplies ink to the ejection unit 10.

The shaping table 20 supports the shaped object 5. The shaping table 20 has a work surface 20a. The ink ejected from the head 11 lands on the work surface 20a. The ink layer is formed on the work surface 20a. By stacking the ink layers on the work surface 20a, the shaped object 5 is formed on the work surface 20a. The shaping table 20 can be moved in the Z direction by a Z drive mechanism 34 of the driving unit 30, which will be described later. The shaping table 20 may be movable in the X direction and the Y direction.

The driving unit 30 moves the ejection unit 10 in the main scanning direction. As the ejection unit 10 moves in the main scanning direction, the plurality of heads 11 provided in the ejection unit 10 move in the main scanning direction. Furthermore, the main scanning operation is, for example, an operation of ejecting ink while moving in a main scanning direction (Y direction in the drawing) set in advance.

The driving unit 30 includes a carriage 31, a Y drive mechanism 32, an X drive mechanism 33, and a Z drive mechanism 34. The carriage 31 holds the ejection unit 10. The carriage 31 is movable in the Y direction (main scanning direction) by the Y drive mechanism 32. The Y drive mechanism 32 moves the carriage 31 in the Y direction. The Y drive mechanism 32 includes a Y guide 32a. The Y guide 32a extends in the Y direction and guides the carriage 31 in the Y direction. The Y drive mechanism 32 includes a driving unit (not illustrated) for moving the carriage 31 in the Y direction. The X drive mechanism 33 moves the Y drive mechanism 32 in the X direction. The X drive mechanism 33 includes an X guide 33a. The X guide 33a guides the Y drive mechanism 32 in the Y direction. The X drive mechanism 33 includes a driving unit (not illustrated) for moving the Y drive mechanism 32 in the X direction. The Z drive mechanism 34 moves the shaping table 20 in the Z direction. The Z drive mechanism 34 includes a Z guide 34a. The Z guide 34a extends in the Z direction and guides the shaping table 20 in the Z direction. The Z drive mechanism 34 includes a driving unit (not illustrated) for moving the shaping table 20 in the Z direction.

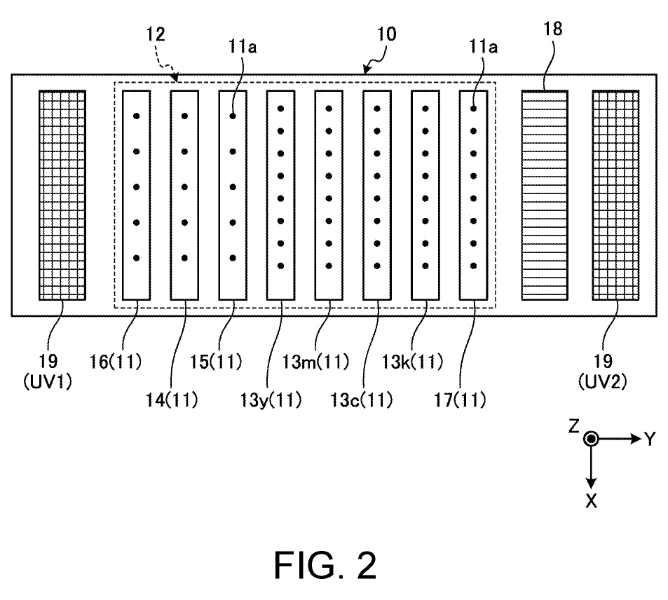

FIG. 2 is a diagram illustrating a configuration of the ejection unit 10 as viewed from below (from the -Z side). As illustrated in FIG. 2, the ejection unit 10 includes a first ink set 12 including a plurality of heads 11. The first ink set 12 includes color ink heads 13y (Y), 13m (M), 13c (C), and 13k (K), a white ink head 14 (W), a clear ink head 15 (CL), a shaping material head 16 (SP1), and a support material head 17 (SP2). Each head 11 includes an ink tank (not illustrated) that stores ink.

The color ink heads 13y to 13k, the white ink head 14, the clear ink head 15, and the shaping material head 16 eject ink containing an ultraviolet-curable resin that cures when irradiated with ultraviolet light, for example. The color ink heads 13y to 13k, the white ink head 14, the clear ink head 15, and the shaping material head 16 are arranged side by side in the main scanning direction (Y direction). The color ink heads 13y to 13k, the white ink head 14, the clear ink head 15, and the shaping material head 16 are arranged with their positions aligned in the sub scanning direction (X direction).

The color ink heads 13y to 13k eject inks of different colors.

The color ink heads 13y to 13k eject ultraviolet-curable ink of each color of yellow (Y), magenta (M), cyan (C), and black (K), respectively. The white ink head 14 ejects white (W) ultraviolet-curable ink.

The shaping material head 16 ejects a shaping ink including a shaping material for forming the outline of the shaped object 5. The shaping material is formed using, for example, an ultraviolet-curable resin that cures when irradiated with ultraviolet light. As the shaping ink, for example, a white ink, a clear ink, or the like can be used. In the present embodiment, the outline of the shaped object 5 is formed with the shaping ink, and the shaped object 5 is colored by forming an ink layer of color ink on the surface of the shaped object 5.

The clear ink head 15 ejects an ultraviolet-curable clear ink. The clear ink is, for example, a colorless and transparent (T) ink. The clear ink is an ink that contains an ultraviolet-curable resin and does not contain a colorant.

The support material head 17 ejects ink containing a support material (S). The support material is used, for example, when supporting a part of the shaped object 5 protruding in the horizontal direction from a position spaced upward from the work surface 20a. The support material contains, for example, an ultraviolet-curable resin. As the support material, a material that can be dissolved with a dissolving liquid such as water after the shaping of the shaped object 5 may be used.

As the support material, a known material may be appropriately used.

The ultraviolet irradiating unit 19 irradiates the ink layer formed on the work surface 20a of the shaping table 20 with ultraviolet light. For example, a light source such as an ultraviolet light emitting diode (LED), a metal halide lamp, or a mercury lamp is used for the ultraviolet irradiating unit 19. The ultraviolet irradiating units 19 (UV1, UV2) are disposed on both sides of the first ink set 12 in the main scanning direction (Y direction).

The flattening roller unit 18 flattens the ink layer formed on the work surface 20a of the shaping table 20. The flattening roller unit 18 is disposed on one side in the main scanning direction (Y direction) with respect to the first ink set 12. The flattening roller unit 18 is disposed between the first ink set 12 and the ultraviolet irradiating unit 19 in the main scanning direction (Y direction). The flattening roller unit 18 includes a flattening roller 18a that comes into contact with the ink layer on the work surface 20a.

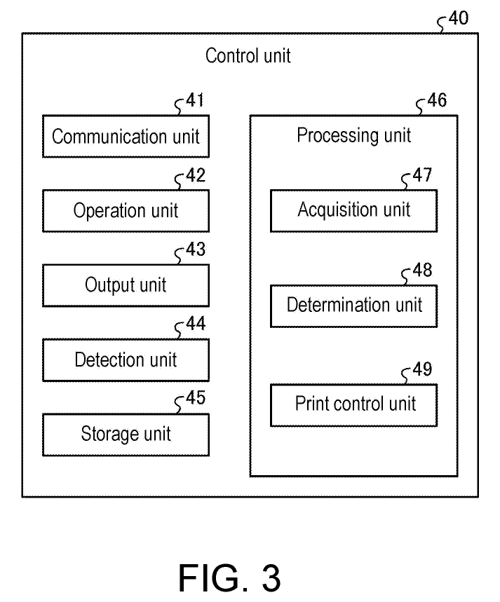

The control unit 40 integrally controls the entire printing apparatus 100. FIG. 3 is a block diagram illustrating an example of the control unit 40. The control unit 40 controls each unit of the printing apparatus 100 to control the operation for shaping the shaped object 5. The control unit 40 includes a communication unit 41, an operation unit 42, an output unit 43, a detection unit 44, a storage unit 45, and a processing unit 46.

The communication unit 41 performs wired or wireless communication with an external device.

The operation unit 42 can input information to the control unit 40. In the present embodiment, examples of the operation unit 42 include a keyboard, a microphone, and a mouse, but are not limited thereto, and other input devices such as a touch panel may be used. The operation unit 42 can input a command for setting a void head, which will be described later, for example, when a user operates the operation unit 42. The operation unit 42 receives shaping information when the user operates the operation unit 42.

The output unit 43 outputs various types of information. The output unit 43 displays, for example, information stored in the storage unit 45 and information output by the processing unit 46. Examples of the output unit 43 include a display device such as a liquid crystal display, but other output devices may be used.

The detection unit 44 detects whether or not each of the plurality of heads 11 is filled with ink. The detection unit 44 may be capable of detecting the amount of ink filled in the plurality of heads 11.

The storage unit 45 stores information such as various programs and data. The storage unit 45 includes a storage such as a hard disk drive (HDD) or a solid state drive (SSD). The storage unit 45 stores setting information related to settings of the plurality of heads 11. The setting information includes ink set information, defect information, and shaping information. The setting information can be set and changed, for example, by the user inputting a predetermined command through the operation unit 42.

The ink set information is information indicating a correspondence relationship between each head 11 and the type of ink ejected from the head 11. The ink set information is stored in the storage unit 45 in a preset state, for example.

The ink set information includes void information. The void information is information related to a setting for treating at least one head 11 among the plurality of heads 11 as a void. Hereinafter, the head 11 treated as a void will be referred to as a void head 11V. Specifically, the void information is information indicating whether or not each of the plurality of heads 11 is set as the void head 11V. The void information can be set and changed for each head 11, for example, by the user inputting a command using the operation unit 42. In the present embodiment, among the plurality of heads 11, the head 11 that is not scheduled to be used in an ejection operation due to a defect such as a lack of ink filling or a clogged nozzle can be set as the void head 11V. Furthermore, for example, in a case where printing can be performed without using some heads 11 among the plurality of heads 11, the some heads 11 can be set as the void head 11V.

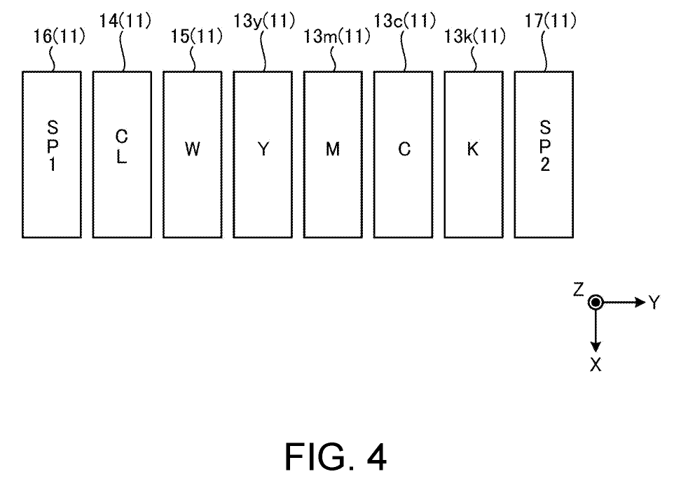

FIG. 4 is a diagram schematically illustrating an example of ink set information. The ink set information illustrated in FIG. 4 (hereinafter referred to as first ink set information) is information indicating a correspondence relationship between the head 11 and the type of ink in the first ink set 12 described above. That is, the first ink set information indicates, from the -Y side to the +Y side, the shaping material head 16 (shaping material), the white ink head 14 (white ink), the clear ink head 15 (clear ink), the color ink head 13y (yellow ink), the color ink head 13m (magenta ink), the color ink head 13c (cyan ink), the color ink head 13k (black ink), and the support material head 17 (support material).

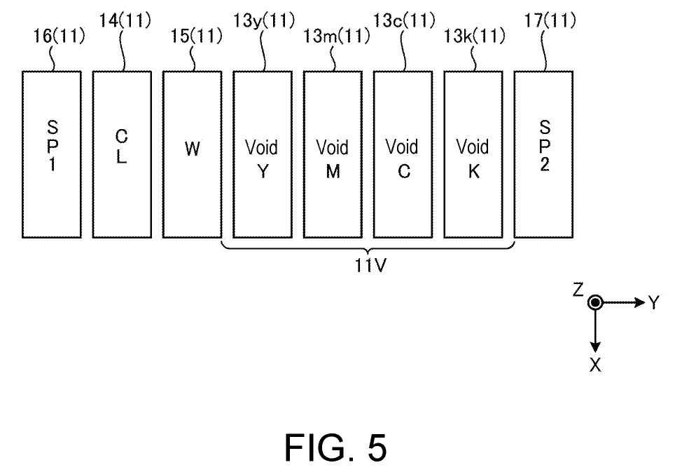

FIG. 5 is a diagram schematically illustrating another example of the ink set information. The ink set information illustrated in FIG. 5 (hereinafter referred to as second ink set information) is obtained by changing the settings of the four color ink heads 13y, 13m, 13c, and 13k of the first ink set information described above as the void head 11V. In this manner, each of the ink set information before and after the setting change can be stored in the storage unit 45 as separate ink set information.

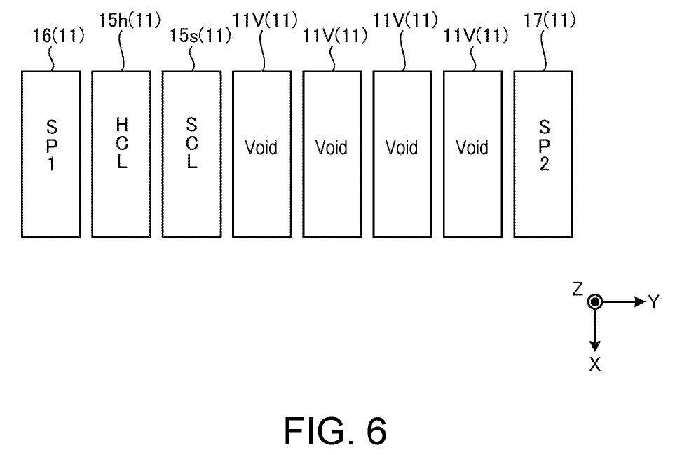

FIG. 6 is a diagram schematically illustrating another example of the ink set information. The ink set information illustrated in FIG. 6 (hereinafter referred to as third ink set information) indicates that, from the -Y side to the +Y side, the shaping material head 16 (shaping material), a clear ink head 15h (hard clear ink), and a clear ink head 15s (soft clear ink) are provided and the next four heads 11 on the +Y side are void heads 11V, and the head 11 closest to the +Y side is the support material head 17 (support material). Thus, the ink set information can be set in advance so that the void head 11V is present and stored in the storage unit 45.

The defect information is information indicating whether or not a defect such as a lack of ink filling or a clogged nozzle 11a has occurred for each of the plurality of heads 11. The defect information can be set or updated based on, for example, a detection result of the detection unit 44 that detects the states of the plurality of heads 11.

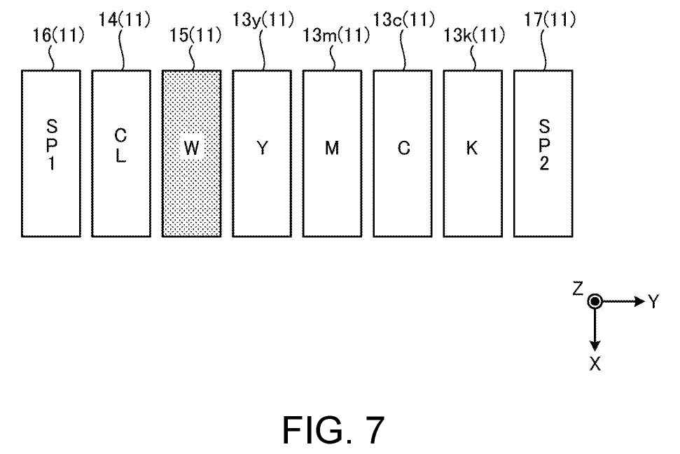

FIG. 7 is a diagram schematically illustrating an example of defect information. The defect information illustrated in FIG. 7 is information indicating whether or not a defect has occurred in each of the heads 11 in the first ink set 12 described above. The example illustrated in FIG. 7 shows a state in which a defect has occurred in the white ink head 14 and no defect has occurred in the other heads 11.

The shaping information includes, for example, shape information about the shape of the shaped object 5 to be shaped, color information about color, and ink used information indicating the type of ink used to form the shaped object 5. Examples of the color information include information indicating the ratio of each color in the CMYK color system, which is the color system of the inks of the printing apparatus 100, but the present disclosure is not limited thereto.

Examples of the ink set information include the following first ink set information, second ink set information, and third ink set information.

Furthermore, for example, when a void head is present among the plurality of heads 11, the storage unit 45 stores a control program of the printing apparatus that performs control to cause the head that is not the void head among the plurality of heads to eject ink and not to cause the void head to eject ink in the ejection operation.

The processing unit 46 performs various types of information processing. The processing unit 46 includes a processor such as a central processing unit (CPU) and a memory such as a read only memory (ROM) and a random access memory (RAM).

The processing unit 46 includes an acquisition unit 47, a determination unit 48, and a print control unit 49.

The acquisition unit 47 acquires the setting information acquired via the communication unit 41 and the setting information stored in the storage unit 45.

The determination unit 48 determines whether or not a defect (such as a lack of ink filling, clogging, or the like) has occurred in each of the plurality of heads 11 based on the defect information. The determination unit 48 determines whether or not the void head 11V is present among the plurality of heads 11 based on the void information. When it is determined that the void head 11V is present, the determination unit 48 determines whether or not ink of a type corresponding to the void head 11V is used in the ejection operation based on the ink set information and the ink used information.

The print control unit 49 controls the printing operation based on the acquired setting information and the determination result of the determination unit 48. The printing operation includes a driving operation of moving the carriage 31 and the shaping table 20 by the driving unit 30, and an ejection operation of ejecting ink from the plurality of heads 11.

The print control unit 49 outputs a defect error when it is determined from the determination result of the determination unit 48 that a defect has occurred in the head 11 that is not the void head 11V, and does not output a defect error when it is determined that a defect has occurred in the void head 11V.

When the type of ink corresponding to the void head 11V is scheduled to be used in the ejection operation, the print control unit 49 outputs an operation error to the output unit 43 and controls not to perform the ejection operation.

From the determination result of the determination unit 48, the print control unit 49 controls not to output an operation error when the type of ink corresponding to the void head 11V is not scheduled to be used.

When the void head 11V is present among the plurality of heads 11 from the determination result of the determination unit 48, the print control unit 49 performs control so that the head 11 that is not the void head 11V among the plurality of heads 11 is caused to eject ink and the void head 11V is not caused to eject ink in the ejection operation. When the void head 11V is not present among the plurality of heads 11 from the determination result of the determination unit 48, the print control unit 49 performs control to eject ink using a necessary head 11 among the plurality of heads 11.

The print control unit 49 causes the ejection operation to be performed while the driving operation is being performed, thereby performing a printing operation. Specifically, the print control unit 49 ejects the ink from the plurality of heads 11 while moving the carriage 31 in the main scanning direction (Y direction) and the sub scanning direction (X direction) to form the ink layer on the work surface 20a of the shaping table 20, and moves the shaping table 20 in the Z direction according to the height of the ink layer to perform the printing operation.

In the control unit 40, the processor in the processing unit 46 reads various programs and loads the programs in the memory, thereby executing information processing corresponding to the functions of the above-described units. Examples of the various programs include a program received by the communication unit 41, a program stored in the storage unit 45, and a program recorded in an external recording medium. The control unit 40 functions as an information processing apparatus (computer) that executes various types of information processing. Note that another information processing apparatus different from the control unit 40 may execute various programs, or the control unit 40 and the other information processing apparatus may execute various programs in cooperation with each other.

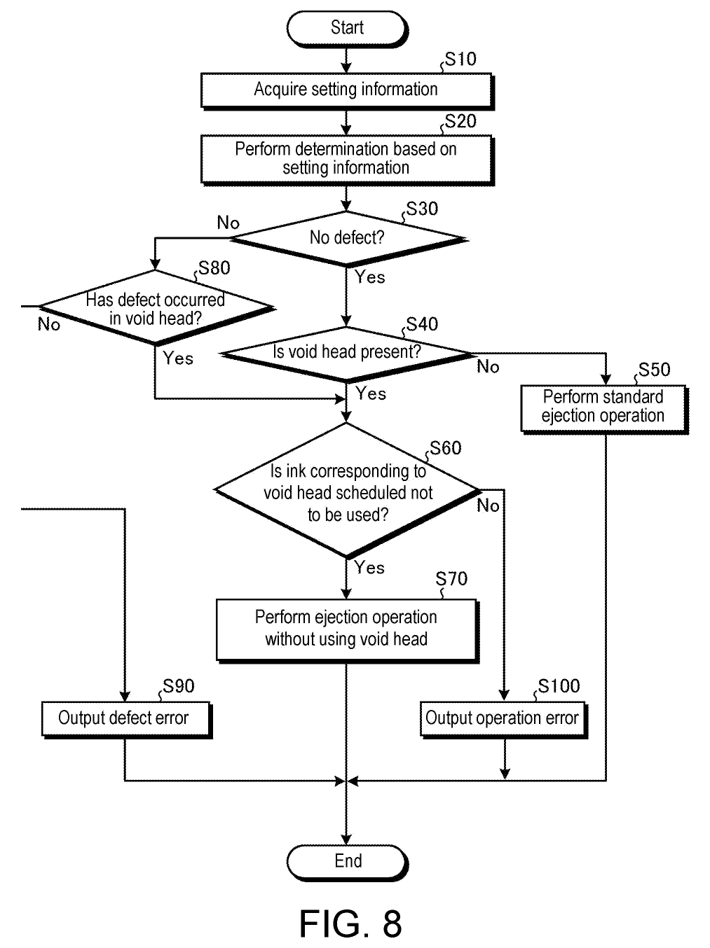

Next, a control method for the printing apparatus 100 will be described. FIG. 8 is a flowchart illustrating an example of a control method for the printing apparatus according to the embodiment. As illustrated in FIG. 8, first, the acquisition unit 47 of the control unit 40 acquires setting information (step S10). In step S10, the acquisition unit 47 acquires each piece of information of the ink set information, the defect information, the void information, and the shaping information.

After the setting information is acquired, the determination unit 48 performs a determination based on the setting information (step S20). In step S20, the determination unit 48 determines whether or not a defect (such as a lack of ink filling, clogging, or the like) has occurred in the plurality of heads 11 based on the defect information. In addition, the determination unit 48 determines whether or not the void head 11V is present among the plurality of heads 11 based on the void information. When it is determined that the void head 11V is present, the determination unit 48 determines whether or not ink of a type corresponding to the void head 11V is scheduled to be used in the ejection operation based on the ink set information and the ink used information.

As a result of the determination in step S20, when no defect has occurred in the plurality of heads 11 (Yes in step S30) and there is no void head 11V in the plurality of heads 11 (No in step S40), the print control unit 49 causes the plurality of heads 11 to perform the normal ejection operation in the printing operation (step S50). That is, in step S50, the print control unit 49 controls a standard ejection operation, that is, the ejecting of the ink using the necessary head 11 based on the shaping information among the plurality of heads 11.

Further, as a result of the determination in step S20, when no defect has occurred in the plurality of heads 11 (Yes in step S30), the void head 11V is present among the plurality of heads 11 (Yes in step S40), and the type of ink corresponding to the void head 11V is scheduled not to be used in the ejection operation (Yes in step S60), the print control unit 49 causes the ejection operation to be performed without using the void head 11V (step S70). In step S70, the print control unit 49 performs control so that the head 11 that is not the void head 11V among the plurality of heads 11 is caused to eject ink and the void head 11V is not caused to eject ink in the ejection operation.

On the other hand, as a result of the determination in step S20, when a defect has occurred in the plurality of heads 11 (No in step S30) and the head 11 in which the defect has occurred is not the void head 11V (No in step S80), the print control unit 49 causes the output unit 43 to output a defect error (step S90).

Further, as a result of the determination in step S20, when no defect has occurred in the plurality of heads 11 (Yes in step S30), the void head 11V is present among the plurality of heads 11 (Yes in step S40), and the type of ink corresponding to the void head 11V is scheduled to be used in the ejection operation (No in step S60), the print control unit 49 causes the output unit 43 to output an operation error (step S100).

As described above, the printing apparatus 100 according to the present embodiment includes the plurality of heads 11 that eject ink, and the control unit 40 that includes the storage unit 45 that stores setting information related to settings of the plurality of heads 11, and causes the plurality of heads 11 to perform an ejection operation that ejects the ink based on the setting information stored in the storage unit 45, the setting information includes void information related to a setting for setting at least one head 11 of the plurality of heads 11 as the void head 11V, and when the void head 11V is present among the plurality of heads 11, the control unit 40 performs control to cause the head 11 that is not the void head 11V among the plurality of heads 11 to eject the ink and not to cause the void head 11V to eject the ink in the ejection operation.

Furthermore, the control method for the printing apparatus 100 according to the present embodiment is a control method for the printing apparatus 100 including the plurality of heads 11 that eject ink, and the control unit 40 that includes the storage unit 45 that stores setting information related to settings of the plurality of heads 11, and causes the plurality of heads 11 to perform an ejection operation that ejects the ink based on the setting information stored in the storage unit 45, the setting information includes void information related to a setting for setting at least one head 11 of the plurality of heads 11 as the void head 11V, and the control method includes performing control, when the void head 11V is present among the plurality of heads 11, to cause the head 11 that is not the void head 11V among the plurality of heads 11 to eject the ink and not to cause the void head 11V to eject the ink in the ejection operation.

According to these configurations, void information is provided as setting information for the plurality of heads 11, and when the void head 11V is present among the plurality of heads 11, control is performed so that the void head 11V is not caused to eject ink in the ejection operation. Therefore, by setting the head 11 that is not scheduled to be used as the void head 11V, the occurrence of errors can be avoided and the ejection operation can be performed efficiently using a plurality of heads. Furthermore, since ink is not ejected from the void head 11V in the ejection operation, there is no need to fill the void head 11V with ink. Therefore, wasteful consumption of ink can be suppressed.

In the printing apparatus 100 according to the present embodiment, the setting information includes defect information indicating whether or not a defect has occurred in each of the plurality of heads 11, and the control unit 40 determines whether or not a head 11 in which a defect has occurred is present among the plurality of heads 11 based on the defect information, and outputs a defect error when it is determined that a defect has occurred in the head 11 that is not the void head 11V, and does not output the defect error when it is determined that the defect has occurred in the void head 11V.

According to this configuration, when it is determined that a defect has occurred in the void head 11V, a defect error is not output, and thus it is possible to perform the ejection operation efficiently using a plurality of heads.

The printing apparatus 100 according to the present embodiment further includes the operation unit 42 capable of inputting a command to change the setting information, the control unit 40 is capable of setting the void head 11V based on the command input by the operation unit 42.

According to this configuration, by inputting a command via the operation unit 42, the desired head 11 can be set as the void head 11V.

In the printing apparatus 100 according to the present embodiment, the setting information includes ink set information indicating a correspondence relationship between each of the heads 11 and a type of ink ejected from the head 11, and ink used information indicating the type of ink used in the ejection operation, and the control unit 40 determines whether or not the type of ink corresponding to the void head 11V is scheduled to be used in the ejection operation based on the ink set information and the ink used information, outputs an operation error and does not perform the ejection operation when it is determined that the type of ink corresponding to the void head 11V is scheduled to be used, and performs the ejection operation without outputting the operation error when it is determined that the type of ink corresponding to the void head 11V is not used.

According to this configuration, when it is determined that the type of ink corresponding to the void head 11V is not used, an operation error is not output and the ejection operation is performed, making it possible to efficiently perform the ejection operation using a plurality of heads.

The technical scope of the present disclosure is not limited to the above-described embodiment, and appropriate modifications can be made without departing from the spirit of the present disclosure. For example, the print control unit 49 may automatically change the settings so that the head 11 determined to have a defect based on the determination result of the determination unit 48 becomes the void head 11V. In this way, since the head 11 in which a defect has occurred among the plurality of heads 11 can be automatically set as the void head 11V by the control unit 40, the labor of the operator in setting can be reduced.

Furthermore, in the above embodiment, the ejection operation has been described by taking, as an example, a case where ink is ejected from the head 11 during a printing operation, but the present disclosure is not limited to this case. The ejection operation may include an operation of ejecting ink from the head 11 or ejecting ink from the head 11 by suction or the like in order to suppress clogging of the nozzles 11a in, for example, a maintenance operation. In this case, consumption of ink in the void head 11V can be avoided even in the maintenance operation.

What is claimed is:

1. A printing apparatus comprising:
a plurality of heads that eject ink; and
a control unit that includes a storage unit that stores setting information related to settings of the plurality of heads, and causes the plurality of heads to perform an ejection operation that ejects the ink based on the setting information stored in the storage unit,
wherein the setting information includes void information related to a setting for setting at least one of the plurality of heads as a void head, and
when the void head is present among the plurality of heads, the control unit performs control to cause the head that is not the void head among the plurality of heads to eject the ink and not to cause the void head to eject the ink in the ejection operation.

2. The printing apparatus according to claim 1,
wherein the setting information includes defect information indicating whether or not a defect has occurred in each of the plurality of heads, and
the control unit determines whether or not a head in which a defect has occurred is present among the plurality of heads based on the defect information, and outputs a defect error when it is determined that a defect has occurred in the head that is not the void head, and does not output the defect error when it is determined that the defect has occurred in the void head.

3. The printing apparatus according to claim 1, further comprising an operation unit capable of inputting a command to change the setting information,
wherein the control unit is capable of setting the void head based on the command input by the operation unit.

4. The printing apparatus according to claim 1, wherein the control unit is capable of setting the head in which a defect has occurred among the plurality of heads as the void head.

5. The printing apparatus according to claim 4,
wherein the setting information includes ink set information indicating a correspondence relationship between each of the heads and a type of ink ejected from the head, and ink used information indicating the type of ink used in the ejection operation, and
the control unit determines whether or not the type of ink corresponding to the void head is scheduled to be used in the ejection operation based on the ink set information and the ink used information, outputs an operation error and does not perform the ejection operation when it is determined that the type of ink corresponding to the void head is scheduled to be used, and performs the ejection operation without outputting the operation error when it is determined that the type of ink corresponding to the void head is not scheduled to be used.

6. A control method for a printing apparatus including
a plurality of heads that eject ink, and
a control unit that includes a storage unit that stores setting information related to settings of the plurality of heads, and causes the plurality of heads to perform an ejection operation that ejects the ink based on the setting information stored in the storage unit,
the setting information including void information related to a setting for setting at least one of the plurality of heads as a void head, the control method comprising:
performing control, when the void head is present among the plurality of heads, to cause the head that is not the void head among the plurality of heads to eject the ink and not to cause the void head to eject the ink in the ejection operation.
